(19) United States
(12) Patent Application Publication
(10) Pub. No.: US 2006/0287427 A1
(43) Pub. Date: Dec. 21, 2006

(54) Floor polish compositions

(75) Inventor: Anton Lukasch, Meitingen (DE)

Correspondence Address: CLARIANT CORPORATION;INTELLECTUAL PROPERTY DEPARTMENT, 4000 MONROE ROAD, CHARLOTTE, NC, 28205, US

(73) Assignee: Clariant Produkte (Deutschland) GmbH

(21) Appl. No.: 11/453,710

(22) Filed: Jun. 15, 2006

(30) Foreign Application Priority Data
Jun. 15, 2005 (DE) 10 2005 027 603.2

(51) Int. Cl. C08L 91/08

(52) U.S. Cl. 524/487

(57) ABSTRACT

The present invention relates to preparations for polishing and treating hard surfaces, preferably floors, which comprise esters of polycarboxylic acids with monoalcohols or of monocarboxylic acids with polyols. In particular embodiments the preparations of the invention may further comprise polymeric(meth)acrylic acid (esters) and/or styrene-(meth)acrylic acid (ester) copolymers and additionally, if desired, polyethylene wax dispersions as well.

The present invention is described in the German priority application No. 102005027603.2, filed 15 Jun. 2005, which is hereby incorporated by reference as is fully disclosed herein.

The invention relates to preparations for polishing hard surfaces, especially floor polish compositions, comprising esters of polycarboxylic acids and monoalcohols and also of monocarboxylic acids and polyols.

Floor polish compositions use primarily polyacrylates and/or styrene-(meth)acrylic acid (ester) copolymers as dispersions and also polyurethane dispersions in a mixture with wax emulsions in order to apply a temporary or more or less permanent protective coat to the floor in question. This protective coat prevents damage to the floor and the penetration of dirt subsequent to linear scratches as a result of dirt particles and/or heel marks, and at the same time provides the floor covering with an aesthetic appearance.

The formulations of floor polish compositions comprising polymer dispersions and wax emulsions typically comprise emulsifiers and plasticizers.

The purpose of these plasticizers is to lower the minimum film-forming temperatures (MFT) of the polymer dispersions to such an extent that the dry-bright emulsions produced from them form a coherent film following application at room temperature. The identity and quantity of the plasticizers are governed by the polymer dispersions used. They need to be such that the protective film is not soiled when traversed, does not stick at elevated temperature, and does not form powder at a low temperature. Plasticization can be achieved through a combination of different plasticizers. Both permanent and temporary plasticizers are used. Permanent plasticizers remain in the protective film, while their temporary counterparts evaporate.

Besides these plasticizers use is made additionally of wetting agents and flow control agents, such as fluorosurfactants or alkaline solutions of wetting resins, or special acrylate dispersions. Whereas the wetting resin solution or the acrylate dispersion here provides uniform leveling of the liquid polish, the effect of the fluorosurfactants is to produce uniform drying of the finished dry-brght emulsion on the floor and to prevent the formation of an uneven, marked polish film.

Permanent plasticizers available include dibutyl phthalate, ε-caprolactam, and tributoxyethyl phosphate (TBEP). Temporary plasticizers include glycols, such as ethyldiglycol, methyldiglycol, and also (N-methyl)-2-pyrrolidone. N-Methyl-2-pyrollidone has recently become suspected of having teratogenic effects. Phthalates are ascribed hormonelike effects; caprolactams, glycol derivatives, and fluorosurfactants are classed as environmental pollutants; and tributoxyethyl phosphate is classed as a possible neurotoxin.

Efforts have therefore been made, and it has been regarded as an object of the invention, to find new substances which are of equal suitability as plasticizers in acrylate-rich dispersions as the substances identified above but which are toxicologically and ecotoxicologically unobjectionable. At the same time the plasticizers ought to take on the functions of wetting agent and flow control agent, from fluorosurfactants for example, and replace them.

Surprisingly it has been found that this object is achieved through the use of esters obtained by reacting polycarboxylic acids with monoalcohols and also by reacting monocarboxylic acids with polyols, in preparations for polishing hard surfaces, especially floor coverings. Esters of this kind exhibit both a plasticizing and a flow-promoting action. In the course of application and drying of the preparations to and on the surfaces, they ensure bubble-free film formation. Hence it is possible to replace both permanent and temporary plasticizers, and fluorosurfactants as well, by polyol esters. It is therefore possible, through the use of these esters, to produce floor polish compositions which contain no phthalates, no fluorosurfactants, no glycol derivatives, and no phosphorus compounds.

The invention provides preparations for polishing hard surfaces, comprising esters obtained by reacting polycarboxylic acids with monoalcohols or by reacting monocarboxylic acids with polyols, of the formula I and/or the formula II and/or the formula III

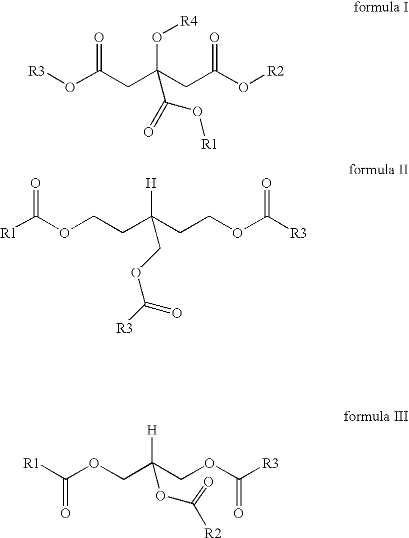

where the radicals R¹, R² and R³ independently of one another are hydrogen, a linear or branched alkyl group having 1 to 30 carbon atoms or are a linear or branched alkenyl group having 2 to 30 carbon atoms, and R⁴ is hydrogen or is an acyl group —C(O)R⁵, where R⁵ is a linear or branched alkyl group having 1 to 30 carbon atoms or is a linear or branched alkenyl group having 2 to 30 carbon atoms, with the proviso that at least one of the radicals, R¹, R², R³ or R⁴, is a hydrocarbon group.

In one preferred embodiment the preparations of the invention for polishing hard surfaces comprise an ester of citric acid of the formula I, preferably esters of citric acid whose alkyl groups R¹, R², and R³ are linear or branched alkyl groups having 1 to 6 carbon atoms. Particularly preferred preparations comprise tributylcitric esters and triethylcitric esters.

The citric esters used in accordance with the invention are prepared by esterifying citric acid with alcohol, examples being methanol, ethanol, propanol, isopropanol, butanol, isobutanol, tert-butanol, pentanol, hexanol, heptanol, octanol, (caprylyl alcohol), octenol, octadienol, nonanol, decanol (capryl alcohol), decenol, decadienol, dodecanol (lauryl alcohol), dodecadienol, ricinoleyl alcohol, myristyl alcohol, cetyl alcohol, stearyl alcohol, cetearyl alcohol, oleyl alcohol, linoleyl alcohol, linolenyl alcohol, arachidyl alcohol, behenyl alcohol, tallow fatty alcohol, palmityl alcohol, coconut fatty alcohol, and guerbet alcohol.

In further preferred embodiments the preparations of the invention for polishing hard surfaces comprise esters of polyols such as trimethylpropane and/or glycerol and monocarboxylic acids of the formula II and III. In this case it is preferred to use monocarboxylic acids having chain lengths of 2 to 12 carbon atoms, more preferably 2 to 8 carbon atoms, very preferably 2 to 6, and with extraordinary preference 2 to 4.

The preparations of the invention for polishing hard surfaces, especially floor coverings, comprise esters of polycarboxylic acids with monoalcohols or of monocarboxylic acids with polyols, of the formula I and/or of the formula II and/or of the formula III, in the weight amounts of 1% to 15% by weight, preferably 2% to 10% by weight, more preferably 2% to 5% by weight, based on the total weight of the finished preparations.

In a further preferred embodiment the preparations of the invention for polishing hard surfaces comprise
a) one or more esters of polycarboxylic acids with monoalcohols or of monocarboxylic acids with polyols, of the formula I and/or of the formula II and/or of the formula III, and
b) one or more polymeric (meth)acrylic acid (esters) and or styrene-(meth)acrylic acid (ester) copolymers containing one or more structural units I 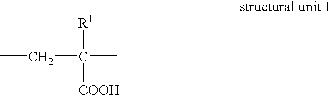
where R¹ is hydrogen or methyl
and/or one or more structural units II 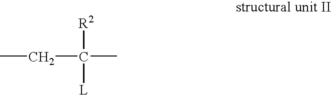
where
R² is hydrogen or methyl and
L is —COOR³, —CONR⁷R⁸ or —COO⁻X⁺,

R³ is a straight-chain or branched alkyl group having 1 to 36 carbon atoms or a straight-chain or branched alkenyl group having 2 to 36 carbon atoms, which if desired may also be alkoxylated and may preferably contain ethyleneoxy (EO), propyleneoxy (PO), butyleneoxy (BO) or EO/PO groups, or

one group is (AO)ₓ—H, where (AO) is an ethoxy, propoxy or butoxy group and x is a number from 1 to 50, or

is a glycidyl group, a C₂-C₁₀ hydroxyalkyl group or is a glycerol group, or

is a cyclic aromatic or nonaromatic group, preferably a cycloalkyl group, having 5 to 8, preferably 6, ring atoms, or

is a cyclic aromatic or nonaromatic group having 5 to 8, preferably 6, ring atoms, the ring being formed of carbon atoms and heteroatoms, preferably O and/or N, and it being possible for not only the carbon atoms but also the nitrogen atoms to be substituted by linear or branched alkyl or alkoxy groups having 1 to 36 carbon atoms or by linear or branched alkenyl or alkenyloxy groups having 2 to 36 carbon atoms, or by acetyl groups —COR⁴ in which R⁴ is an alkyl group having 1 to 22 carbon atoms, or

is —(CR⁵R⁶)_{y}-cycloalkyl or is —CR⁵R⁶)_{y}-aryl, where R⁵ and R⁶ each independently of one another are H or a linear or branched alkyl group having 1 to 4 carbon atoms and y is a number from 1 to 10, or

is a perfluoroalkyl group having 8 to 18 carbon atoms,

R⁷ and R⁸ each independently of one another are hydrogen, or

are a straight-chain or branched alkyl group having 1 to 36 carbon atoms or a straight-chain or branched alkenyl group having 2 to 36 carbon atoms, which if desired may also be alkoxylated and may preferably contain ethyleneoxy (EO), propyleneoxy (PO), butyleneoxy (BO) or EO/PO groups, or

are a (C₂-C₁₀)-hydroxyalkyl group, or

are —CH₂—CH₂—N(CH₃)₂ or are a polyamine radical, or are a cyclic aromatic or nonaromatic group, preferably a cycloalkyl group, having 5 to 8, preferably 6 ring atoms, or

are a cyclic aromatic or nonaromatic group having 5 to 8, preferably 6, ring atoms, the rings being formed of carbon atoms and heteroatoms, preferably O and/or N, and it being possible for not only the carbon atoms but also the nitrogen atoms to be substituted by linear or branched alkyl or alkoxy groups having 1 to 36 carbon atoms or by linear or branched alkenyl or alkenyloxy groups having 2 to 36 carbon atoms, or by acetyl groups —COR⁹ in which R⁹ is an alkyl group having 1 to 22 carbon atoms, or

R⁷ and R⁸, together with the nitrogen atom to which they are attached, form a 5-, 6- or 7-membered aromatic or nonaromatic ring, and the rings besides the nitrogen atom contain preferably only CH₂ groups, X⁺ is Li⁺, Na⁺, K⁺, Mg⁺⁺/2, Ca⁺⁺/2, Al⁺⁺⁺/3, NH₄⁺, a monoalkylammonium, dialkylammonium, trialkylammonium and/or tetraalkylammonium ion, the alkyl substituents of the ammonium ions being able independently of one another to be (C₁-C₂₂)-alkyl radicals or (C₂-C₁₀)-hydroxyalkyl radicals, and

if desired one or more structural units III

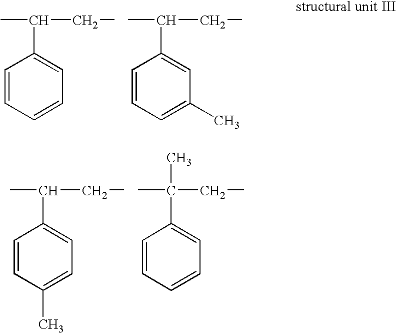

which derive from styrene, 3-methylstyrene, 4-methylstyrene or α-methylstyrene.

The structural units I are a result of polymerization of unsaturated carboxylic acids CH₂═CR¹—COOH in which R¹ is hydrogen or methyl; the structural units II are apparent, for example, through polymerization of unsaturated compounds of the formula CH₂═CR²-L in which R² and L possess the definitions specified above.

The polymeric (meth)acrylic acid (esters) and/or styrene-(meth)acrylic acid (ester) copolymers employed in the preparations of the invention are prepared by free-radical emulsion polymerization at temperatures in the range from 75 to 80° C. and have a film-forming temperature between 0 and 80° C.

The polymers employed with preference comprise a (meth)acrylate copolymer formed from 1 to 30 parts by weight of carboxyl-containing monomers, 30 to 70 parts by weight of monomers which form homopolymers having glass transition temperatures below 20° C., preferably C₁-C₆ alkyl esters of acrylic acid and/or the C₄-C₈ alkyl esters of methacrylic acid, and 30 to 70 parts by weight of monomers which form homopolymers having glass transition temperatures above room temperature, preferably C₁-C₃ alkyl esters of (meth)acrylic acid, or styrene, based on the respective copolymer.

One particularly preferred comonomer whose homopolymer has a glass transition temperature above room temperature is styrene.

In particularly preferred embodiments the preparations of the invention comprise the acrylate copolymers ®Licomer M55, ®Licomer M63, ®Licomer M72 (Clariant GmbH).

In the preferred embodiments the preparations of the invention comprise polymeric (meth)acrylic acid (esters) and/or styrene-(meth)acrylic acid (ester) copolymers having a film-forming temperature between 0 and 80° C. in the weight amounts of 5% to 45%, preferably 5% to 30%, more preferably 8% to 20%, of polymeric (meth)acrylic acid (esters) and/or styrene-(meth)acrylic acid (ester) copolymers, calculated as pure polymer or copolymer, based on the finished preparation.

In a further preferred embodiment the preparations of the invention for polishing hard surfaces comprise polyethylene wax dispersions.

Preference is given to using ®Licomer W11 and ®Licomer W19 (Clariant GmbH).

®Licomer W11 and ®Licomer W19 are secondary polyethylene wax dispersions prepared by emulsifying oxidized polyethylene waxes at 120 to 150° C. under a pressure of from 2 to 6 bar.

In the preferred embodiments the preparations of the invention comprise polyethylene wax dispersions in the weight amounts of 5% to 45%, preferably 5% to 30%, more preferably 8% to 20%, of polyethylene wax, calculated as pure polymer, based on the finished preparation.

The preparations of the invention further typically comprise emulsifiers, surfactants, preservatives, fragrances, and dyes.

Nonionic emulsifiers available are preferably adducts of 0 to 30 mol of ethylene oxide and/or 0 to 5 mol of propylene oxide with linear fatty alcohols having 6 to 30 carbon atoms, preferably 10 to 22 carbon atoms, and very preferably 14 to 22 carbon atoms, hydroxylated if desired. Examples which can be employed include octanol (caprylyl alcohol), octenol, octadienol, decanol (capryl alcohol), decenol, decadienol, dodecanol (lauryl alcohol), dodecadienol, ricinoleyl alcohol, myristyl alcohol, cetyl alcohol, stearyl alcohol, cetearyl alcohol, oleyl alcohol, linoleyl alcohol, linolenyl alcohol, arachidyl alcohol, and behenyl alcohol. It is also possible to use fatty alcohol fractions which are obtained by reduction of naturally occurring glycerides, such as bovine tallow, palm oil, peanut oil, colza oil, cottonseed oil, soybean oil, sunflower oil, and linseed oil, or which are produced from transesterification products with corresponding alcohols from fatty acid esters and therefore represent a mixture of different fatty alcohols. Substances of this kind are available commercially for example under the name Stenol®, e.g., Stenol® 1618, or Lanette®, e.g., Lanette® O and Lanette®22, or Lorol®, e.g., Lorol®C18.

A further class of inventively preferred emulsifiers are adducts of 0 to 30 mol of ethylene oxide and/or 0 to 5 mol of propylene oxide with linear and/or branched, saturated and/or unsaturated fatty acids having 6 to 30 carbon atoms, preferably 10 to 22 carbon atoms. Mention may be made of isostearic acid, such as the commercial products Emersol®871 and Emersol®875, isopalmitic acids such as Edenor®IP95, and all other fatty acids purchasable under the trade name Edenor® (Cognis). Further typical examples of such fatty acids are caproic acid, caprylic acid, 2-ethylhexanoic acid, capric acid, lauric acid, isotridecanoic acid, myristic acid, palmitic acid, palmitoleic acid, stearic acid, isostearic acid, oleic acid, elaidic acid, petroselinic acid, linoleic acid, linolenic acid, elaeosteric acid, arachidic acid, gadoleic acid, behenic acid, erucic acid, and dimers of unsaturated fatty acids, and also technical mixtures thereof. Particular preference is given to fatty acid fractions from coconut oil or palm oil; stearic acid is especially preferred.

A further class of preferred emulsifiers are esters from unalkylated or alkylated sugars with C₆-C₃₀ fatty acids. Sugars which can be used are any monosaccharides or oligosaccharides. It is usual to use monosaccharides having 5 or 6 carbon atoms, examples being ribose, xylose, lyxose, altose, glucose, fructose, galactose, arabinose, altrose, mannose, gulose, idose, and talose, and also the deoxy sugars rhamnose and fucose. Sugars having 4 carbon atoms can also be used, such as erythrose and threose.

Inventively preferred oligosaccharides are composed of two to 10 monosaccharide units, examples being sucrose (saccharose), lactose or trehalose. Preferred sugar units are the monosaccharides glucose, fructose, galactose, and arabinose, and the disaccharide sucrose. Glucose and sucrose are particularly preferred. The sugars may have been partially etherified with methyl, ethyl, propyl, isopropyl or butyl groups, examples being methylglucoside, ethylglucoside or butylglucoside. For the esterification it is possible to use all C₆-C₃₀ fatty acids and mixtures thereof as cited above. Suitability is possessed in principle by monoesterified and polyesterified sugars. Preference is given to the monoesters, sesquiesters, and diesters, examples being sucrose monostearate, sucrose distearate, sucrose monococoate, sucrose dicocoate, methylglucoside monostearate, methylglucoside sesquistearate, methylglucoside isostearate, ethylglucoside monolaurate, ethylglucoside dilaurate, ethylglucoside monococoate, ethylglucoside dicocoate, and butylglucoside monococoate.

A further class of preferred emulsifiers are C₈-C₂₂ alkyl-monoglycosides and oligoglycosides conforming to the general formula RO-(Z)ₓ, where R is a C₈-C₂₂ alkyl group, Z is the sugar, and x is the number of sugar units. The alkyl-monoglycosides and -oligoglycosides which can be used in accordance with the invention may contain only one particular alkyl radical R. Particular preference is given to those alkyl-monoglycosides and -oligoglycosides in which R is composed essentially of C₈ and C₁₀ alkyl groups, essentially of C₁₂ and C₁₄ alkyl groups, essentially of C₈ to C₁₆ alkyl groups, or essentially of C₁₂ to C₁₆ alkyl groups. As sugar unit Z it is possible to use any desired monosaccharides or oligosaccharides, as cited above. Preferred sugar units are glucose, fructose, galactose, arabinose and sucrose, with glucose being particularly preferred. The inventively useful alkyl-monoglycosides and -oligoglycosides contain on average 1.1-5, preferably 1.1-2.0, and more preferably 1.1-1.8 sugar units.

The alkoxylated homologs of the aforementioned alkyl-monoglycosides and -oligoglycosides can also be used with preference in accordance with the invention. These homologs may contain on average up to 10 ethylene oxide units and/or propylene oxide units per alkylglycoside unit. Suitable alkylglycosides in this context are, for example, cocoylglucoside, decylglucoside, laurylglucoside, cetearylglucoside, and arachidylglucoside.

A further class of preferred emulsifiers are the partial esters of propylene glycol, glycerol, and sorbitan with C₈-C₂₂ fatty acids. For the esterification it is possible to use all C₈-C₂₂ fatty acids and mixtures thereof, as already cited above. Particularly appropriate examples are propylene glycol monostearate, glycerol monolaurate, glycerol monostearate, glycerol distearate, glycerol monooleate, sorbitan monolaurate, sorbitan dilaurate, sorbitan monostearate, sorbitan sesquistearate, sorbitan distearate, sorbitan monoisostearate, sorbitan monooleate, sorbitan dioleate or the commercial products Monomuls®90-0, Monomuls®90-L 12, and Cutina®MD. These emulsifiers may contain on average up to 10 ethylene oxide units and/or propylene oxide units per molecule.

A further preferred class of emulsifiers are polyglycerols of the formula HO—CH₂—CHOH—CH₂[—O—CH₂—CHOH—CH₂]ₙ—O—CH₂—CHOH—CH₂OH with n=0-8 and esters thereof with linear and branched C₈-C₂₂ fatty acids, which may carry functional groups in the alkyl chain, preferably polyglyceryl-2 dipolyhydroxystearate (commercial product Dehymuls® PGPH) and polyglyceryl-3 diisostearate (commercial product Lameform® TGI).

Preferred nonionic surfactants are fatty alcohol oxethylates containing about 1 to about 25 mol of ethylene oxide. The alkyl chain of the aliphatic alcohols may be linear or branched, primary or secondary, and contains in general from 8 to 22 carbon atoms. Particular preference is given to the condensation products of alcohols containing an alkyl chain of 10 to 20 carbon atoms with 2 to 18 mol of ethylene oxide per mole of alcohol. The alkyl chain may be saturated or else unsaturated. The alcohol ethoxylates may also exhibit a narrow homolog distribution of the ethylene oxide (narrow range ethoxylates) or a broad homolog distribution of the ethylene oxide (broad range ethoxylates). Examples of commercially available nonionic surfactants include the Genapol™ grades from Clariant GmbH.

Examples of suitable preservatives include phenoxyethanol, parabens, isothiazolinones or sorbic acid.

The preparations of the invention for polishing hard surfaces, particularly floor polish compositions, can be produced by simple mixing of the ingredients, which can be introduced as solids or in solution into an automatic mixer.

The preparations of the invention may be in the form of what are called standard products, of concentrates, or of pastes, the skilled worker being aware that the transitions between these products are fluid.

Standard products are generally liquid and constitute solutions or dispersions of their ingredients. The concentrates are solutions or emulsions of the ingredients and have a liquid to viscous consistency.

Application may take place manually or in typical automatic cleaners, and is accomplished, for example, by applying the polish solution and by subsequent drying, to form a thin polish film.

The preparations of the invention are suitable for polishing hard surfaces, especially floor coverings made up of tiles, including fine porcelain tiles, natural stone slabs, but also floors with elastic coverings such as linoleum and PVC.

Examples below are intended to illustrate the invention without restricting it to them. All percentages are by weight unless otherwise indicated.

### EXAMPLES

### Example 1 and Example 2

Floor polish composition with phthalate, glycol, and phosphate (TBEP) (example 1) and floor polish composition with tributyl citrate, no phthalate, glycol, and phosphate (TBEP) (example 2)

| Ingredients | Example 1 | Example 2 |
|---|---|---|
| Ethyldiglycol | 2.64% | 0% |
| Tributoxyethyl phosphate | 0.88% | 0% |
| Dibutyl phthalate | 0.88% | 0% |
| Tributyl citrate | 0% | 3.5% |
| ® Licomer M 55 | 37.4% | 37.4% |
| ® Alresat 640 C solution (20%) | 4.8% | 4.8% |
| ® Licomer W 19 | 6.7% | 6.7% |
| ® Genapol X-060 | 0.8% | 0.8% |
| ® Licowet F 3 | 1.0% | 1.0% |
| deionized water | ad 100% | ad 100% |
| Gloss (PVC, second application) | 78% | 83% |

The gloss was determined in accordance with DIN 67530 or ISO 2813 (determination of the reflectometer value of coatings under an angle of 60°).

In floor traffic tests, no differences were apparent even after several weeks between the two formulations (example 1 and example 2).

### Production of Examples 1 and 2

Water and plasticizers (ethylene diglycol, tributoxyethyl phosphate and/or tributyl citrate) were mixed at room temperature with thorough stirring for a period (t) of 5 to 10 minutes. The individual ingredients were added in succession in the order stated, with stirring. This was followed by intensive stirring (t=30 minutes).

### Examples 3, 4, and 5

### Floor Polish Compositions with Tributyl Citrate but without Fluorosurfactant

### Example 3

| Water, deionized | ad 100% |
|---|---|
| Tributyl citrate | 4.4 |
| Diethylaminoethanol | 0.4 |
| ® Licomer M 55 | 37.4 |
| ® Licomer W 19 | 6.7 |
| ® Alresat 640 C solution (20%) | 4.8 |
| ® Genapol X-080 | 0.8% |
| ® Saniprot 94-08 | 0.1% |

### Example 4

| Water, deionized | ad 100% |
|---|---|
| Diethylaminoethanol | 0.4 |
| Tributyl citrate | 5.2 |
| ® Licomer M 63 | 37.4 |
| ® Licomer W 19 | 7.3 |
| ® Alresat 640 C solution(20%) | 5.0 |
| ® Genapol X-080 | 0.9% |
| ® Saniprot 94-08 | 0.1% |

### Example 5

| Water, deionized | ad 100% |
|---|---|
| Diethylaminoethanol | 0.4 |
| Tributyl citrate | 4.1 |
| ® Licomer M 72 | 36.8 |
| ® Licomer W 19 | 7.9 |
| ® Daotan VTW 1265 | 5.5% |
| ® Alresat 640 C solution (20%) | 5.6% |
| ® Genapol X-080 | 0.9% |
| ® Saniprot 94-08 | 0.1% |

### Mode of Production of Examples 3, 4, and 5

Water and tributyl citrate were mixed with intensive stirring for a period (t) of 5 to 10 minutes. Subsequently the individual ingredients were added in the order stated, with stirring. This was followed by intensive stirring (t=30 minutes).

Chemical identification of the commercial products employed:

| | | |
|---|---|---|
| ® Licomer M 55 | (Clariant GmbH) | acrylate copolymer dispersion |
| ® Licomer M 63 | (Clariant GmbH) | acrylate copolymer dispersion |
| ® Licomer M 72 | (Clariant GmbH) | acrylate copolymer dispersion |
| ® Licomer W 19 ® | (Clariant GmbH) | polyethylene wax dispersion |
| ® Alresat 640 C | | modified rosin |
| solution (20%) | | |
| ® Genapol X-060 | (Clariant GmbH) | isotridecyl alkoxylate (6EO) |
| ® Genapol X-080 | (Clariant GmbH) | isotridecyl alkoxylate (8EO) |
| ® Licowet F 3 | (Clariant GmbH) | fluorosurfactant |
| ® Daotan VTW | Surface Specialities | polyurethane resin |
| 1265 | Germany GmbH | |
| | & Co KG | |
| ® Saniprot 94-08 | (Sanitized AG) | preservative |

1. A preparation for polishing hard surfaces, comprising at least one ester obtained by reacting polycarboxylic acids with monoalcohols or by reacting monocarboxylic acids with polyols, wherein the at least one ester is of the formula I, the formula II, the formula III or mixtures thereof 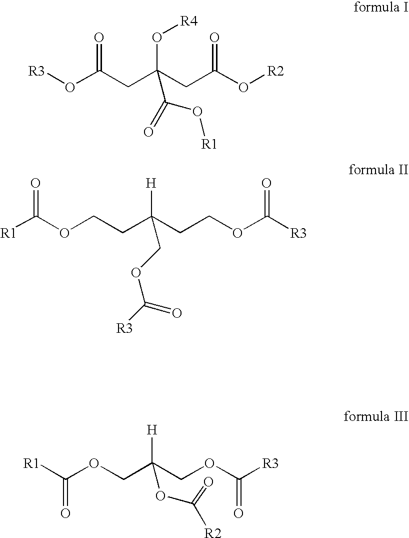
where the radicals R¹, R² and R³ independently of one another are hydrogen, a linear or branched alkyl group having 1 to 30 carbon atoms or are a linear or branched alkenyl group having 2 to 30 carbon atoms, and R⁴is hydrogen or an acyl group —C(O)R⁵, where R⁵ is a linear or branched alkyl group having 1 to 30 carbon atoms or a linear or branched alkenyl group having 2 to 30 carbon atoms, with the proviso that at least one of the radicals, R¹, R², R³ or R⁴, is a hydrocarbon group.

2. The preparation for polishing hard surfaces, as claimed in claim 1, wherein the at least one ester is an ester of citric acid, of the formula I, wherein R¹, R² and R³ are linear or branched alkyl groups having 1 to 8 carbon atoms.

3. The preparation for polishing hard surfaces as claimed in claim 1, wherein the at least one ester is a tributylcitric ester or triethylcitric ester.

4. The preparation for polishing hard surfaces as claimed in claim 1, wherein the at least one ester is an ester of polyols.

5. The preparation for polishing hard surfaces as claimed in claim 1, wherein the at least one ester is present in an amount of 1% to 15% by weight, based on the total weight of the preparation.

6. The preparation for polishing hard surfaces as claimed in claim 1, further comprising
a) the at least one ester,
b) one or more polymeric (meth)acrylic acid (esters), styrene-(meth)acrylic acid (ester) copolymers or a mixture thereof containing one or more structural units I 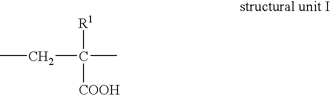
where R¹ is hydrogen or methyl
one or more structural units II or a mixture of structural units I and II 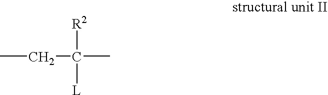
where
R² is hydrogen or methyl and
L is —COOR³, —CONR⁷R⁸ or —COO⁻X⁺,
R³ is a straight-chain or branched alkyl group having 1 to 36 carbon atoms, a straight-chain or branched alkenyl group having 2 to 36 carbon atoms, optionally, alkoxylated, or
is a glycidyl group, a C₂-C₁₀ hydroxyalkyl group or a glycerol group, or is a cyclic aromatic or nonaromatic group having 5 to 8 ring atoms or
is —(CR⁵R⁶)_{y}-cycloalkyl or is —(CR⁵R⁶)_{y}-aryl, where R⁵ and R⁶ each independently of one another are H or a linear or branched alkyl group having 1 to 4 carbon atoms and y is a number from 1 to 10, or
is a perfluoroalkyl group having 8 to 18 carbon atoms,
R⁷ and R⁸ each independently of one another
are hydrogen,
a straight-chain or branched alkyl group having 1 to 36 carbon atoms, a straight-chain or branched alkenyl group having 2 to 36 carbon atoms, optionally alkoxylated a (C₂-C₁₀)-hydroxyalkyl group,
—CH₂—CH₂—N(CH₃)₂ a polyamine radical,
a cyclic aromatic or nonaromatic group having 5 to 8 ring atoms, or
R⁷ and R⁸, together with the nitrogen atom to which they are attached, form a 5-, 6- or 7-membered aromatic or nonaromatic ring,
X⁺ is Li⁺, Na⁺, K⁺, Mg⁺⁺/2, Ca⁺⁺/2, Al⁺⁺⁺/3, NH₄⁺, a monoalkylammonium, dialkylammonium, trialkylammonium, tetraalkylammonium ion or mixtures thereof, the alkyl substituents of the ammonium ions are independently of one another (C₁-C₂₂)-alkyl radicals or (C₂-C₁₀)-hydroxyalkyl radicals, and
optionally one or more structural units III 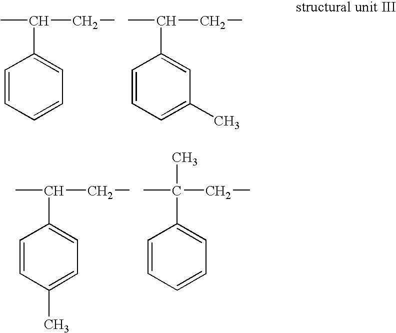
wherein structural unit III is derived from styrene, 3-methylstyrene, 4-methylstyrene or α-methylstyrene.

7. The preparation for polishing hard surfaces as claimed in claim 6, wherein component b) further comprises a (meth)acrylate copolymer formed from 1 to 30 parts by weight of carboxyl-containing monomers, 30 to 70 parts by weight of monomers which form homopolymers having glass transition temperatures below 20° C. and 30 to 70 parts by weight of monomers which form homopolymers having glass transition temperatures above room temperature.

8. The preparation for polishing hard surfaces as claimed in claim 6 wherein component b) further comprises polymeric (meth)acrylic acid (esters) copolymers, styrene-(meth)acrylic acid (ester) copolymers or mixtures thereof having a film-forming temperature between 0 and 80° C. in amounts of 5% to 45% by weight, calculated as pure polymer or copolymer, based on the total weight of the finished preparation.

9. The preparation for polishing hard surfaces as claimed in claim 1, further comprising at least one polyethylene wax dispersion.

10. The preparation for polishing hard surfaces as claimed in claim 9, wherein the at least one polyethylene wax dispersion is a secondary polyethylene wax dispersion prepared by emulsifying oxidized polyethylene waxes at temperatures from 120 to 150° C. under a pressure of from 2 to 6 bar.

11. The preparation for polishing hard surfaces as claimed in claim 9, wherein the at least one polyethylene wax dispersion is present in an amount of 5% to 45% by weight, calculated as pure polymer, based on the total weight of the preparation.

12. The preparation for polishing hard surfaces as claimed in claim 2, wherein R¹, R² and R³ are linear or branched alkyl groups having 2 to 6 carbon atoms.

13. The preparation for polishing hard surfaces as claimed in claim 4, wherein the ester of polyols is trimethylolpropane, glycerol or both and monocarboxylic acids of the general formulae II, III or both.

14. The preparation for polishing hard surfaces as claimed in claim 13, wherein the monocarboxylic acids have 2 to 8 carbon atoms.

15. The preparation for polishing hard surfaces as claimed in claim 13, wherein the monocarboxylic acids have 2 to 6 carbon atoms.

16. The preparation for polishing hard surfaces as claimed in claim 13, wherein the monocarboxylic acids have 2 to 4 carbon atoms.

17. The preparation for polishing hard surfaces as claimed in claim 1, wherein the at least one ester is present in an amount of 2% to 10% by weight, based on the total weight of the preparation.

18. The preparation for polishing hard surfaces as claimed in claim 1, wherein the at least one ester is present in an amount of 2% to 5% by weight, based on the total weight of the preparation.

19. The preparation as claimed in claim 6, wherein R³ is a straight-chain or branched alkyl group having 1 to 36 carbon atoms. or a straight-chain or branched alkenyl group having 2 to 36 carbon atoms, and contains ethyleneoxy (EO), propyleneoxy (PO), butyleneoxy (BO) or EO/PO groups, or
one group is (AO)ₓ—H, where (AO) is an ethoxy, propoxy or butoxy group and x is a number from 1 to 50.

20. The polishing preparation as claimed in claim 6, wherein R³ is the cycloalkyl group having 6 ring atoms.

21. The polishing preparation as claimed in claim 6, wherein R³ is the cyclic aromatic or nonaromatic group having 5 to 8 ring atoms, wherein the ring atoms are formed of carbon atoms and heteroatoms, wherein the caron atoms and heteroatoms are substituted by linear or branched alkyl or alkoxy groups having 1 to 36 carbon atoms, linear or branched alkenyl or alkenyloxy groups having 2 to 36 carbon atoms, or acetyl groups —COR⁴ in which R⁴ is an alkyl group having 1 to 22 carbon atoms.

22. The polishing preparation as claimed in claim 21, wherein the carbon atoms and heteroatoms are O, N or both.

23. The polishing preparation as claimed in claim 6, wherein R⁷ and R⁸are each independently of one another are a straight-chain or branched alkyl group having 1 to 36 carbon atoms or a straight-chain or branched alkenyl group having 2 to 36 carbon atoms containing ethyleneoxy (EO), propyleneoxy (PO), butyleneoxy (BO) or EO/PO groups.

24. The preparation for polishing as claimed in claim 6, wherein R⁷ and R⁸ are each independently of one another the cyclic aromatic or nonaromatic group having 5 to 8 ring atoms, wherein the ring atoms are O, N or both, wherein the O, N or both are optionally substituted by linear or branched alkyl or alkoxy groups having 1 to 36 carbon atoms or by linear or branched alkenyl or alkenyloxy groups having 2 to 36 carbon atoms, or by acetyl groups —COR⁹ in which R⁹ is an alkyl group having 1 to 22 carbon atoms.

25. The preparation for polishing as claimed in claim 6, wherein R⁷ and R⁸ are each independently of one another a cyclic aromatic or nonaromatic group having 6 ring atoms.

26. The preparation for polishing as claimed in claim 6, wherein R⁷ and R⁸, together with the nitrogen atom to which they are attached, form a 5-, 6- or 7-membered aromatic or nonaromatic ring, and the rings besides the nitrogen atom contain preferably only CH₂ groups.

27. The preparation for polishing as claimed in claim 7, wherein the monomers which form homopolymers having glass transition temperatures below 20° C. are C₁-C₆ alkyl esters of acrylic acid, C₄-C₈ alkyl esters of methacrylic acid or a mixture thereof.

28. The preparation for polishing as claimed in claim 7, wherein the monomers which form homopolymers having glass transition temperatures above room temperature, are C₁-C₃ alkyl esters of (meth)acrylic acid or styrene.

29. The preparation for polishing hard surfaces as claimed in claim 6, wherein component b) further comprises polymeric (meth)acrylic acid (esters) copolymers, styrene-(meth)acrylic acid (ester) copolymers or mixtures thereof having a film-forming temperature between 0 and 80° C. in amounts of 5% to 30% by weight, calculated as pure polymer or copolymer, based on the total weight of the preparation.

30. The preparation for polishing hard surfaces as claimed in claim 6, wherein component b) further comprises polymeric (meth)acrylic acid (esters) copolymers, styrene-(meth)acrylic acid (ester) copolymers or mixtures thereof having a film-forming temperature between 0 and 80° C. in amounts of 8% to 20% by weight, calculated as pure polymer or copolymer, based on the total weight of the preparation.

31. The preparation for polishing hard surfaces as claimed in claim 9, wherein the at least one polyethylene wax dispersion is present in an amount of 5% to 30% by weight, calculated as pure polymer, based on the total weight of the preparation.

32. The preparation for polishing hard surfaces as claimed in claim 9, wherein the at least one polyethylene wax dispersion is present in an amount of 8% to 20% by weight, calculated as pure polymer, based on the total weight of the preparation.
